(19) United States
(12) Patent Application Publication
(10) Pub. No.: US 2017/0173875 A1
(43) Pub. Date: Jun. 22, 2017

(54) 3D printing device for producing a spatially extended product

(71) Applicant: LILAS GmbH, Dortmund (DE)

(72) Inventor: Vitalij LISSOTSCHENKO, Froendenberg (DE)

(21) Appl. No.: 15/380,924

(22) Filed: Dec. 15, 2016

(30) Foreign Application Priority Data
Dec. 17, 2015 (DE) 10 2015 122 130.6
Apr. 15, 2016 (DE) 10 2016 107 058.0

(51) Int. Cl. B29C 67/00; B33Y 30/00

(52) U.S. Cl. CPC B29C 67/0077; B33Y 30/00; B29K 2105/251

(57) ABSTRACT

A 3D printing device for producing a spatially extended product, having at least one first laser light source (1) from which a first laser radiation (2) emerges, a working area (4) to which starting material for the 3D printing to which laser radiation (2) is applied or supplied, wherein the working area (4) is arranged in the 3D printing device such that the laser radiation (2) is incident on the working area (4), scanning arrangements (3, 7) which are designed in particular as movable mirrors, wherein the scanning arrangements are capable of supplying the laser radiation intentionally to specific locations in the working area (4), and arrangements for preheating the starting material in the working area, wherein the arrangements for preheating include at least one second laser light source (5) from which a second laser radiation (6) emerges.

This is an application claiming priority to 10 2015 122 130.6 filed on Dec. 17, 2015 and DE 10 2016 107 058.0 filed on Apr. 15, 2016, which applications are incorporated by reference in their entirety.

### BACKGROUND OF THE INVENTION

The present invention relates to a 3D printing device for producing a spatially extended product according to the preamble of claim 1.

In conventional 3D printing devices, for example, a quantity of energy is applied point-shaped with a laser beam to a starting material which is fed in powder form, so as to initiate at the location where the energy is applied a process, for example melting or sintering of the starting material, wherein this process causes the grains of the starting material to fuse. The product to be manufactured is thus produced layer-by-layer by scanning the laser radiation across the working area in a grid pattern.

3D printing devices are known where the starting material is preheated. This has the advantage that the total heating of the starting material need not be effected by the laser radiation, which is, for example, guided over the starting material in a grid-like pattern. A disadvantage of this 3D printing device is that the entire product is heated by the pre-heating, so that a lengthy cool-down process must take place after the 3D printing.

### BRIEF SUMMARY OF THE INVENTION

The task underlying the present invention is the creation of a 3D printing device which is more effective, in particular faster than the prior art devices.

According to the invention, this is achieved with a 3D printing device of the type mentioned at the beginning and having the characterizing features of claim 1. The dependent claims relate to preferred embodiments of the invention.

According to claim 1, the means for preheating include at least one second laser light source from which a second laser radiation can emerge. This makes it possible to preheat the starting material only locally so that either no cool-down phase at all or only a very short cool-down phase needs to be performed following the 3D printing process.

During the operation of the 3D printing device, the area on which the at least one first laser radiation is incident in the working area may be smaller than the area on which the at least one second laser radiation is incident in the working area, wherein the area of incidence of the at least one first laser radiation during the operation of the 3D printing device is moved relative to the area of incidence of the at least one second laser radiation.

Furthermore, during the operation of the 3D printing device, the at least one first laser radiation and the at least one second laser radiation may overlap in the working area at least in sections, wherein the area of incidence of the at least one first laser radiation in the working area is smaller than the area of incidence of the at least one second laser radiation in the working area, and wherein during operation of the 3D printing device, the area of incidence of the at least one first laser radiation is moved relative to the area of incidence of the at least one second laser radiation inside the area of incidence of the at least one second laser radiation.

For example, the first laser light source may be a fiber laser and the second laser light source may be a semiconductor laser or a CO₂ laser.

### BRIEF DESCRIPTION OF THE DRAWINGS

Other features and advantages of the present invention will be apparent from the following description of preferred embodiments with reference to the accompanying drawings, wherein:

FIG. 1 is a schematic diagram of a first embodiment of a 3D printing device according to the invention;

FIG. 2 shows a schematic diagram of a first arrangement of areas of incidence of the at least one first laser radiation and the at least one second laser radiation in the working plane, indicating the movement of these regions and with a schematic intensity distribution of the at least one second laser radiation;

FIG. 3 is a schematic diagram of a second arrangement of areas of areas of incidence of the at least one first laser radiation and the at least one second laser radiation in the working plane, indicating the movement of these regions and with a schematic intensity distribution of the at least one second laser radiation;

FIG. 4 is a schematic diagram of a third arrangement of areas of incidence of the at least one first laser radiation and the at least one second laser radiation in the working plane, indicating the movement of these regions and with a schematic intensity distribution of the at least one second laser radiation;

FIG. 5 shows a schematic diagram of a fourth arrangement of areas of incidence of the at least one first laser radiation and the at least one second laser radiation in the working plane, indicating the movement of these regions and with a schematic intensity distribution of the at least one second laser radiation;

FIG. 6 shows a schematic diagram of a fifth arrangement of areas of incidence of the at least one first laser radiation and the at least one second laser radiation in the working plane, indicating the movement of these regions and with a schematic intensity distribution of the at least one second laser radiation;

FIG. 7 shows a schematic diagram of a sixth arrangement of areas of incidence of the at least one first laser radiation and the at least one second laser radiation in the working plane, indicating the movement of these regions and with a schematic intensity distribution of the at least one second laser radiation;

FIG. 8 is a schematic diagram of a seventh arrangement of areas of incidence of the at least one first laser radiation and the at least one second laser radiation in the working plane, indicating the movement of these regions and with a schematic intensity distribution of the at least one second laser radiation;

FIG. 9 is a schematic diagram of an eighth arrangement of areas of incidence of the at least one first laser radiation and the at least one second laser radiation in the working plane, indicating the movement of these regions and with a schematic intensity distribution of the at least one second laser radiation;

FIG. 10 shows a schematic diagram of a ninth arrangement of areas of incidence of the at least one first laser radiation and the at least one second laser radiation in the working plane, indicating the movement of these regions and with a schematic intensity distribution of the at least one second laser radiation;

FIG. 11 shows a schematic diagram of a tenth arrangement of areas of incidence of the at least one first laser radiation and the at least one second laser radiation in the working plane, indicating the movement of these regions and with a schematic intensity distribution of the at least one second laser radiation;

FIG. 12 shows a schematic diagram of an eleventh arrangement of areas of incidence of the at least one first laser radiation and the at least one second laser radiation in the working plane, with an indication of the movement of these regions and with a schematic intensity distribution of the at least one second laser radiation; and

FIG. 13 shows a perspective view of a second embodiment of a 3D printing device according to the invention.

### DETAILED DESCRIPTION OF THE INVENTION

In the figures, identical and functionally identical parts are provided with the same reference symbols.

The embodiment of a 3D printing device according to the invention depicted in FIG. 1 includes at least one first laser light source 1, from which a first laser radiation 2 emanates. The first laser light source 1 may be a fiber laser. The first laser radiation 2 is directed or focused into the working area 4 where a starting material to be processed is disposed, in particular a starting material supplied in form of a powder, by way of schematically indicated scanning means 3 which, for example, include two movable mirrors and, if appropriate, suitable optics such as F-theta objectives.

The illustrated 3D printing device furthermore includes at least one second laser light source 5, from which a second laser radiation 6 emanates. The second laser light source 5 may be a semiconductor laser or a CO₂ laser and may in particular have higher power than the first laser light source 1.

The second laser radiation 6 is directed to the left in FIG. 1 onto a semi-transparent mirror 8, which is designed in particular as a dielectric dichroic mirror, by way of schematically indicated scanning means 7, which include, for example, two movable mirrors and, if appropriate, suitable optics such as F-theta objectives. The mirror 8 deflects the second laser radiation 6 into the working area 4 so that the second laser radiation 6 is incident thereon together with the first laser radiation 2. Instead of the mirror 8, other combining means such as, for example, polarization-selective components may also be used for combining the two laser radiations 2, 6.

The starting material is pre-heated by the second laser radiation 6, wherein a process, such as melting or sintering of the starting material, is initiated by additionally applying the first laser radiation 2 at the location where the second laser radiation 6 is applied, wherein this process causes the grains of the starting material to fuse together. The product to be produced is created layer-by-layer by scanning the laser radiations 2, 6 across the working area.

In the illustrated embodiment, different scanning means 3, 7 are provided for the first and second laser radiation 2, 6. However, the two laser radiations 2, 6 may also be deflected by the same scanning means. In this case, the semi-transparent mirror can be omitted.

Furthermore, no scanning means may be arranged between the at least one second laser light source 5 and the mirror 8, and the mirror 8 itself may be designed to be movable.

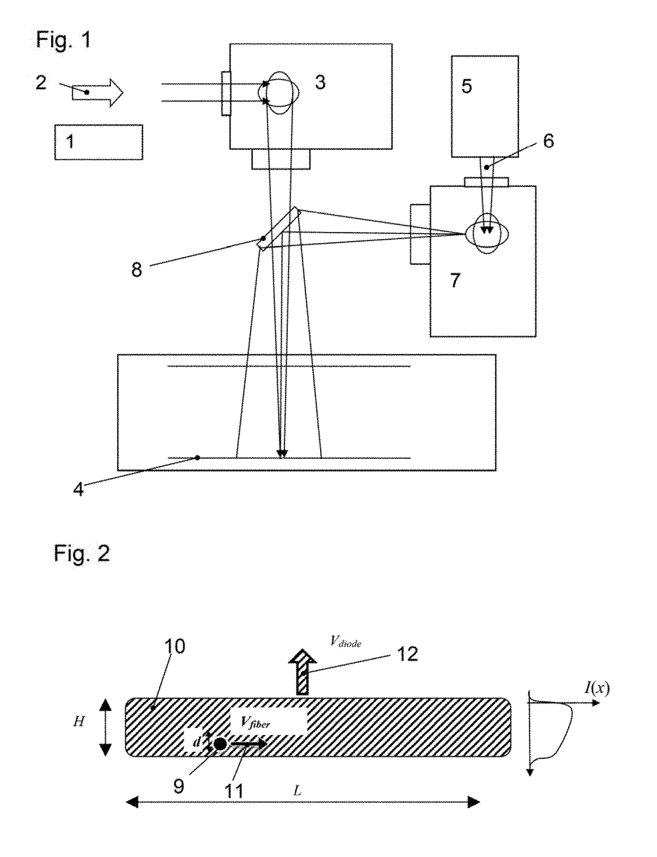

FIG. 2 shows schematically the areas of incidence 9, 10 of the first and the second laser radiation 2, 6 on the working area. In this case, the area of incidence 9 of the first laser radiation 2 is essentially circular and has a small diameter d. However, the area of incidence may for example also have a square contour. Small structures of the 3D component to be produced can be achieved due to the small size of the area of incidence 9 or the focus region of the first laser radiation 2. The area of incidence 9 of the first laser radiation 2 is moved along the arrow 11 inside the area of incidence 10 of the second laser radiation.

Conversely, the area of incidence 10 of the second laser radiation 6 is comparatively large and has a rectangular contour with a length L and a height H. Other contours and sizes are also possible. The intensity distribution of the second laser radiation 6 may be inhomogeneous, in particular may have an intensity distribution that changes over the height H, as indicated at the right-hand margin of FIG. 2. As a result, the intensity in the region of the upper edge of the area of incidence 10 is greater than in the region of the lower edge.

The area of incidence 10 of the second laser radiation 6 is moved upwards along the arrow 12 in FIG. 2. Due to the intensity distribution of the second laser radiation 6 and due to the movement, energy is supplied uniformly into the powder to be processed, in particular to be melted.

The intensity distribution of the second laser radiation may also be designed differently and may, for example, be homogeneous or may have a gradient in the longitudinal direction.

The second laser radiation 6 is moved across the sections of the working area 4 where the powder is to be solidified at the respective location of the starting material. The size of the sections to which the second laser radiation is applied therefore depends on the contour of the component to be produced.

The second laser radiation 2, which is ultimately responsible for the point-wise solidification of the starting material, is moved in the area of incidence 10 of the second laser radiation 6. This may be effected, for example, by means of a zigzag movement. In particular, the first laser radiation may be incident substantially in the region of the rear edge of the area of incidence 10 of the second laser radiation 6, wherein the rear edge is in FIG. 2 the lower edge or the edge facing away from the direction of movement 12.

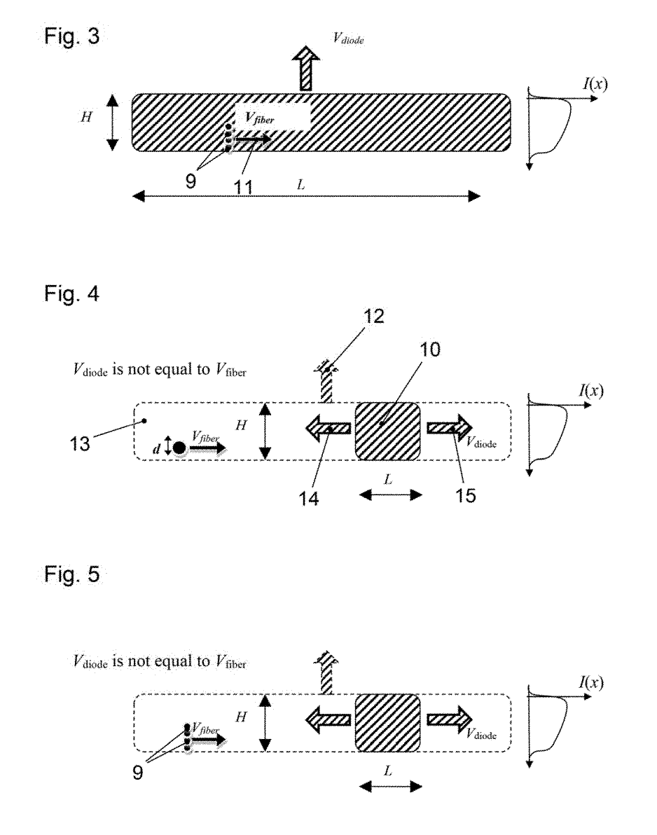

In contrast to FIG. 2, FIG. 3 shows several areas of incidence 9 of the first laser radiation 2 or of several first laser radiations 2. The areas of incidence 9 may be moved in parallel and simultaneously in the direction of the arrow 11.

In particular, a plurality of first laser light sources 1 may be provided, which in particular may be controlled separately and produce a plurality of first laser radiations 2. As a result, the solidification of the starting material can take place simultaneously in the several areas of incidence 9, wherein depending on the contour of the component to be produced, specific areas of incidence may be omitted in certain sections of the working area.

In particular, a plurality of second laser light sources 5 may also be provided, which may in particular be controlled separately and generate several second laser radiations 6. As a result, the starting material can thus be preheated in the several areas of incidence 10 at the same time, wherein depending on the contour of the component to be produced, specific areas of incidence may be omitted in certain sections of the working area.

In the exemplary embodiment according to FIG. 3, four areas of incidence 9 of first laser radiation 2 are shown. More or fewer areas of incidence 9 may be present, for example 10 or 20 or 100 areas of incidence 9.

FIG. 4 shows a smaller area of incidence 10 of the second laser radiation 6. This area of incidence 10 is moved back and forth along the arrows 14, 15 in a section 13 of the working area to be pre-heated, wherein simultaneously or at a later time, the area of incidence 10 is moved upwards in the direction of the arrow 12 in FIG. 4, as in the example illustrated in FIG. 2. Uniform preheating can also be achieved by this movement of the area of incidence 10.

FIG. 5 corresponds to FIG. 4, except for the use of several first laser radiations 2 and correspondingly several areas of incidence 9.

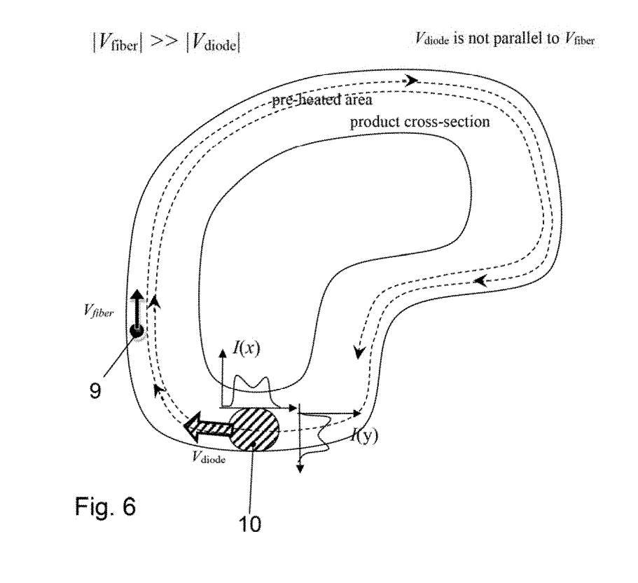

FIG. 6 shows an embodiment wherein both the path of the area of incidence 10 of the second laser radiation 6 as well as the path of the area of incidence 9 of the first laser radiation 2 is adapted to the contour of the component to be produced. This results, for example, in a spiral path for the area of incidence 9 of the first laser radiation.

In order to achieve optimally uniform pre-heating with this path of the area of incidence 10 of the second laser radiation 6 adapted to the contour of the component, the intensity distribution of the second laser radiation 6 can be adapted commensurately. For example, an M-shape may be provided, as shown in FIG. 5.

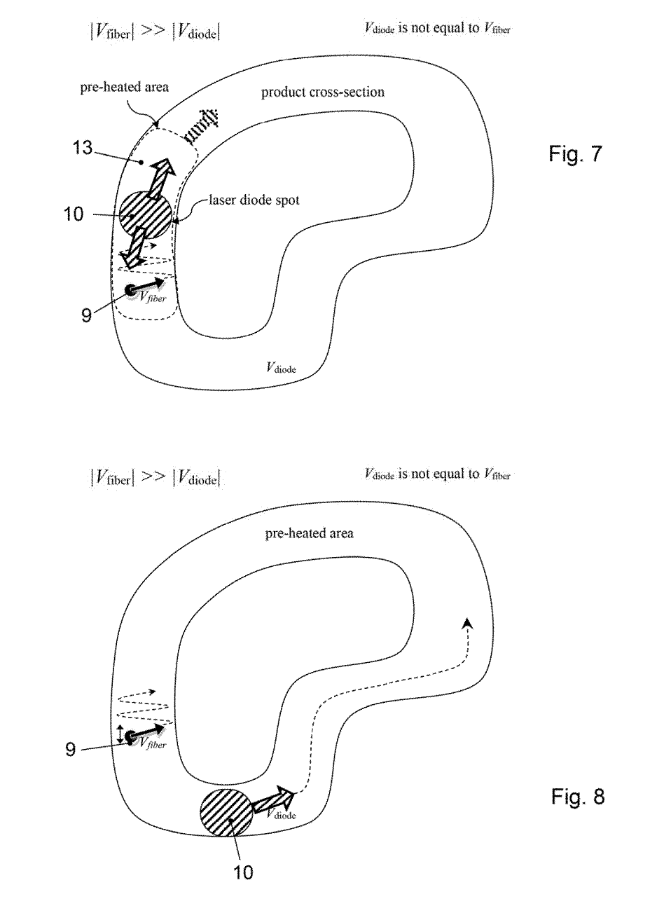

FIG. 7 shows an embodiment wherein the area of incidence 9 of the first laser radiation 2 is moved in a zigzag pattern in the section 13 that is pre-heated by the area of incidence 10 of the second laser radiation 6. The area of incidence 9 of the first laser radiation 2 hereby moves on average in the same direction as the section 13 in which the area of incidence 10 of the second laser radiation 6 moves back and forth. In FIG. 7, both the section 13 and the area of incidence 9 of the first laser radiation 2 move on average in the clockwise direction.

FIG. 8 shows an embodiment wherein the area of incidence 9 of the first laser radiation 2 moves clockwise in a zigzag pattern and the area of incidence 10 of the second laser radiation 6 moves counterdockwise.

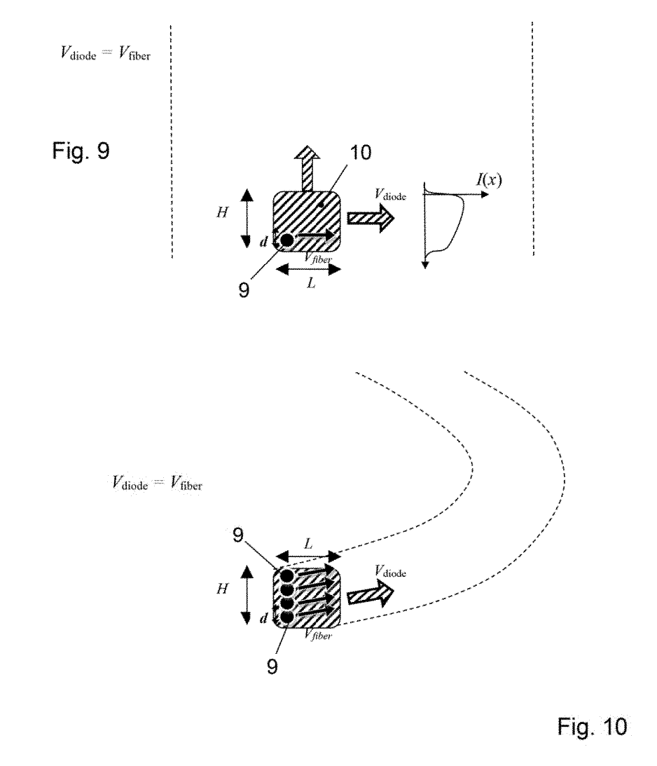

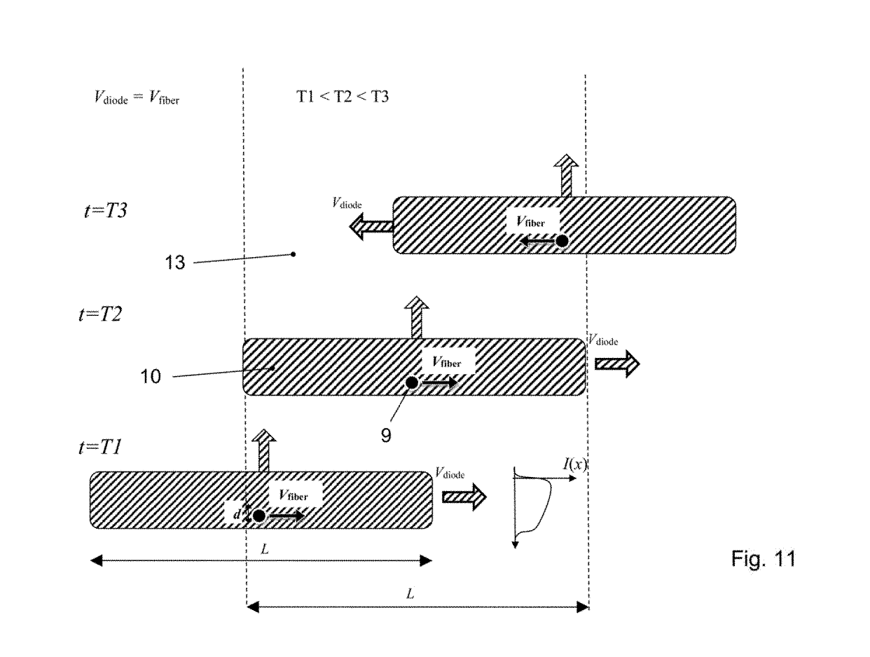

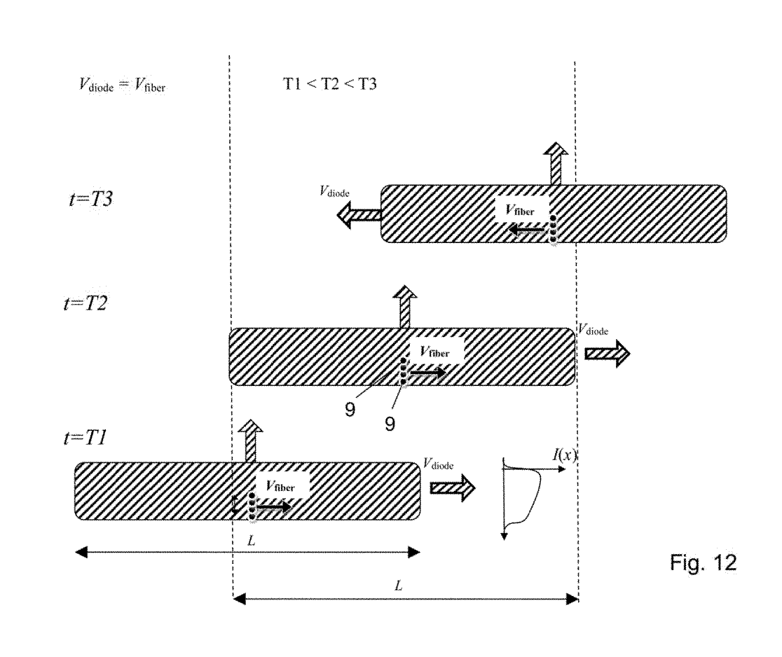

FIG. 9 and FIG. 10 show embodiments wherein the areas of incidence 9, 10 are moved essentially synchronously across the working area. Only a first laser radiation 2 is present in FIG. 9, whereas the areas of incidence 9 of several first laser radiations 2 are indicated in FIG. 10.

FIG. 11 and FIG. 12 show several embodiments wherein the area of incidence 10 of the second laser radiation 6 is moved back and forth and projects laterally in sections beyond the section 13 to be preheated. As a result, very homogeneous pre-heating can be achieved. Disadvantageously, sections of the working area disposed outside the area required for the production of the 3D part are also being heated.

Only a first laser radiation 2 is present in FIG. 11, whereas the areas of incidence 9 of several first laser radiations 2 are indicated in FIG. 12.

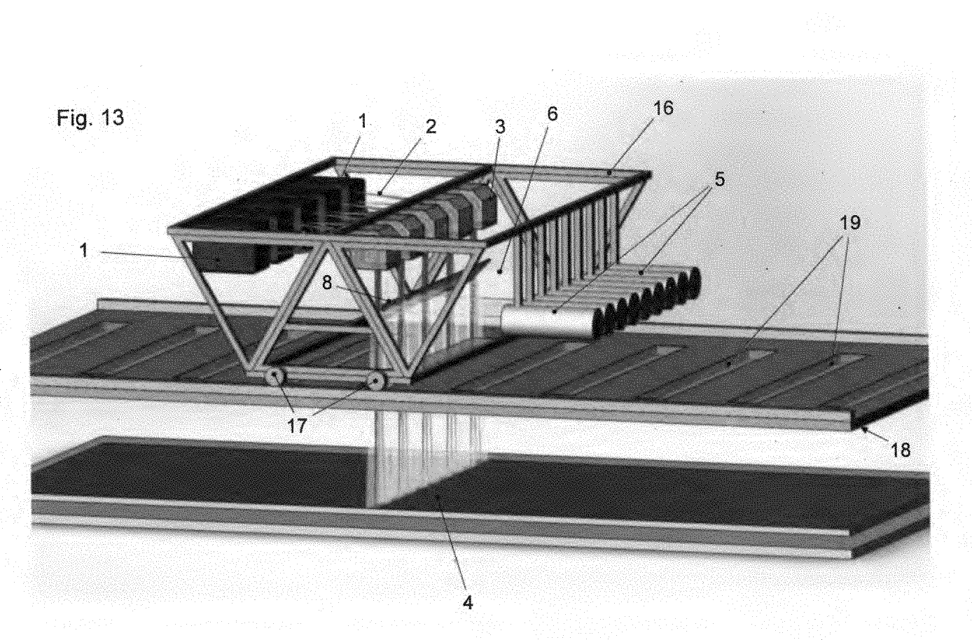

In the embodiment of a 3D printing device according to the invention illustrated in FIG. 13, a plurality of first laser light sources 1 and a plurality of second laser light sources 5 are provided. A respective scanning means 3 which has two movable mirrors is provided for each first laser radiation 2 of the first laser light sources 1. These mirrors may, in particular, have a piezo-based drive.

No separate scanning means are provided for the laser radiation 6 from the second laser light sources 5. Rather, the semi-transparent mirrors 8, which combine the laser radiation 2, 6, are designed to be movable so that the second laser radiations 6 can be scanned across the working area.

The first laser light sources 1, the second laser light sources 5, the scanning means 3 and the mirrors 8 are combined into an, in particular, mobile unit. For this purpose, a frame 16 is provided in which the above-mentioned parts are supported. The frame 16 has on its underside rollers 17 which allow the frame 16 to move on a platform 18 that is arranged above and spaced apart from the working area 4.

Several windows 19 through which the laser radiations 2, 6 can pass are provided in the platform 18. When the section of the working area 4 located under one of the windows 19 has been processed, the frame 16 can be moved to the next window 19, allowing another section of the working area to be processed.

In this way, very large components can be produced very effectively by 3D printing.

Every issued patent, pending patent application, publication, journal article, book or any other reference cited herein is each incorporated by reference in their entirety.

1. A 3D printing device for producing a spatially extended product, comprising
at least one first laser light source (1) from which a first laser radiation (2) can emerge,
a working area (4) to which a starting material to which the laser radiation (2) for 3D printing is applied and is supplied, wherein the working area (4) is arranged in the 3D printing device in such a way that the laser radiation (2) is incident on the working area (4),
scanning arrangements (3, 7), wherein the scanning arrangements are capable to supply the laser radiation (2) specifically to desired locations in the working area (4),
arrangements for preheating the starting material in the working area,
wherein the arrangements for preheating comprise at least one second laser light source (5) from which a second laser radiation (6) emerges.

2. The 3D printing device according to claim 1, wherein during operation of the 3D printing device the area of incidence (9) of the at least one first laser radiation in the working area (4) is smaller than the area of incidence (10) of the at least second laser radiation (6) in the working area (4), wherein the area of incidence (9) of the at least one first laser radiation (2) during operation of the 3D printing device is moved relative to the area of incidence (10) of the at least one second laser radiation (6).

3. The 3D printing device according to claim 1, wherein during operation of the 3D printing device the at least one first laser radiation (2) and the at least one second laser radiation (6) overlap in the working area at least in sections, wherein the area of incidence (9) of the at least one first laser radiation (2) is smaller in the working area (4) than the area of incidence (10) of the at least one second laser radiation (6) in the working area (4), and wherein the area of incidence (9) of the at least one first laser radiation (2) is moved during operation of the 3D printing device relative to the area of incidence (10) of the at least one second laser radiation (6) inside the area of incidence (10) of the at least one second laser radiation (6).

4. The 3D printing device according to claim 1, wherein the first laser radiation (2) has a greater resolution or smaller focus areas in the working area than the second laser radiation (6).

5. The 3D printing device according to claim 1, wherein the first laser light source (1) is a fiber laser.

6. The 3D printing device according to claim 1, wherein the second laser light source (5) is a semiconductor laser or a CO₂ laser.

7. The 3D printing device according to claim 1, wherein a plurality of first laser light sources (1) and/or a plurality of first laser radiations (2) having each at least one focus area in the working area are provided.

8. The 3D printing device according to claim 1, wherein a plurality of second laser light sources (5) and/or a plurality of second laser radiations (6) having each at least one focus area in the working area are provided.

9. The 3D printing device according to claim 1, wherein the at least one first laser light source (1) or the plurality of first laser light sources (1) is designed in such a way that during operation of the device several spaced-apart points of incidence or spaced-apart areas of incidence (9) of the laser radiation (2) are generated in the working area (4).

10. The 3D printing device according to claim 9, wherein the scanning arrangements (3) are designed in such a way that the points of incidence or areas of incidence (9) of the first laser radiation (2) in the working area (4) is movable in the direction or perpendicular to the direction in which the points of incidence or areas of incidence (9) of the laser radiation (2) are arranged next to one another.

11. The 3D printing device according to claim 1, wherein the at least one first laser radiation (2) and the at least one second laser radiation (6) overlap in the working area at least in sections and/or are incident in time in quick succession.

12. The 3D printing device according to claim 1, wherein the at least one second laser radiation (6) heats the starting material to be solidified and the at least one first laser radiation (2) supplies additional energy to the starting material in such a way that the solidification process is affected.

13. The 3D printing device according to claim 1, wherein the 3D printing device comprises optical arrangements, and wherein the optical arrangement are designed to focus the first and/or the second laser radiation (2, 6) in the working area (4).

14. The 3D printing device according to claim 1, wherein the intensity distribution of the second laser radiation (6) in the working area (4) is homogeneous or inhomogeneous.

15. The 3D printing device according to claim 1, wherein the scanning arrangements (3, 7) are designed as movable mirrors.

16. The 3D printing device according to claim 12, wherein the solidification process is effected by melting or sintering.

17. The 3D printing device according to claim 13, wherein optical arrangements are designed as an F-theta objective or flat-field scanning objectives and are arranged between the scanning arrangements and the working area (4).

18. The 3D printing device according to claim 14, wherein the intensity distribution of the second laser radiation (6) in the working area (4) has an intensity gradient in the direction in which the intensity distribution of the second laser radiation (6) is moved in the working area (4).
